(19) United States
(12) Patent Application Publication
(10) Pub. No.: US 2014/0005306 A1
(43) Pub. Date: Jan. 2, 2014

(54) Hyaluronic Acid-Gelatin Crosslinked Thermoreversible Pluronic Hydrogels

(71) Applicants: Polytechic Institute of New York University, Brooklyn, NY (US); The Research Foundation of State University of New York, Albany, NY (US)

(72) Inventors: Miriam Rafailovich, Plainview, NY (US); Divya Bhatnagar, Highland Park, NJ (US); Mary K. Cowman, Mohegan Lake, NY (US)

(73) Assignees: Polytechnic Institute of New York University, Brooklyn, NY (US); The Research Foundation of State University of New York, Albany, NY (US)

(21) Appl. No.: 13/924,104

(22) Filed: Jun. 21, 2013

Related U.S. Application Data
(60) Provisional application No. 61/662,724, filed on Jun. 21, 2012.

(51) Int. Cl. C08L 89/00; C08L 5/08; C08L 71/02

(52) U.S. Cl. CPC C08L 89/00; C08L 71/02; C08L 5/08
USPC 524/18

(57) ABSTRACT

A HA-gelatin-pluronic hydrogel and a method for making a HA-gelatin-pluronic hydrogel are provided. The hydrogel includes hyaluronic acid, gelatin-Type A and a thermoreversible, hydrophilic non-ionic surfactant gel. The thermoreversible, hydrophilic non-ionic surfactant gel can be a poly(ethylene oxide)99-poly(propylene oxide)67-poly(ethylene oxide)99 (“Pluronic F127”). The weight ratio of HA to gelatin-Type A is between 1:2 and 2:1 and preferably about 1:1. The weight ratio of HA and gelatin-Type A to thermoreversible, hydrophilic non-ionic surfactant gel is between 1:3,000 and 1:150, preferably between 1:3,000 and 1:600 and most preferably about 1:2,400. The hydrogel is formed by combining hyaluronic acid and gelatin-Type A to form a solution, cooling the solution, mixing the solution with Pluronic F127 to form a mixture and storing the mixture at a temperature of from 25° C. to 45° C. preferably about 37° C., to form a gel

This application claims priority based on provisional patent application Ser. No. 61/662,724, filed on Jun. 21, 2012, which is incorporated herein by reference in its entirety.

This invention was made with government support under grant number DMR 0606387 awarded by the National Science Foundation, Division of Materials Research. The government has certain rights in the invention.

### FIELD OF THE INVENTION

The present invention relates to hyaluronic acid (“HA”) hydrogels. In particular, the present invention relates to HA hydrogels that are formed by crosslinking and include a thermoreversible, hydrophilic non-ionic surfactant gel.

### BACKGROUND OF INVENTION

As the field of regenerative medicine becomes more complex, there grows an increasing need for new biomaterials that can act as effective scaffolds and targeted delivery systems for cells, peptides, and drugs. These materials must have the necessary biological and mechanical properties to direct the growth and protection of the desired tissue within the body. Promising candidates that are currently under research are hydrogel matrices.

Pluronic copolymers are popular for numerous biomedical applications, such as drug delivery vehicles, since their gelation properties are thermoreversible and easily controlled by varying the concentration. They are liquid below room temperature and gel at body temperature. Hence, they are easily injected and can become a gel as they reach body temperature. Furthermore, the range of modulus achieved is easily superimposed on that of soft body tissues. In general, the copolymer Pluronic F127 aqueous solution is in a unimer state at low temperatures and low polymer concentration, since both blocks (PEO and PPO) are water soluble at low temperatures. Increasing the temperature causes the formation of spherical micelles with a core of mainly the hydrophobic PPO blocks and a water-swollen corona of PEO blocks. It has been previously shown that at high concentrations the micelles organized into a cubic structure and that the ordered micelle structures are due to repulsive interactions among closely packed spherical micelles. Hence, the material is a “micelle gel” as opposed to a chemical gel where the components are linked by covalent bonds.

Gels formed from pluronic copolymers have many applications for use as cell scaffolds and in drug delivery systems, as well as other applications. However, there is a need for a gel that has a stiffness that can be controlled for various applications. Therefore, there is a need for a gel composition that can be adapted for various uses under a range of different environmental conditions.

### SUMMARY OF THE INVENTION

In accordance with the present invention, a HA-gelatin-pluronic hydrogel is provided. The hydrogel comprises, consists of or consists essentially of hyaluronic acid (“HA”), gelatin-Type A and a thermoreversible, hydrophilic non-ionic surfactant gel. Preferably, gelatin-Type A has an isoelectric range between 7 and 9 pH. The thermoreversible, hydrophilic non-ionic surfactant gel can be poly(ethylene oxide)99-poly(propylene oxide)67-poly(ethylene oxide)99 (“Pluronic F127”). The weight ratio of HA to gelatin-Type A is between 1:2 and 2:1 and preferably about 1:1. The weight ratio of HA and gelatin-Type A to thermoreversible, hydrophilic non-ionic surfactant gel is between 1:3,000 and 1:150, preferably between 1:3,000 and 1:600 and most preferably about 1:2,400.

The present invention is also a method for forming a hydrogel that comprises, consists of or consists essentially of: combining hyaluronic acid (“HA”) and gelatin-Type A to form a solution, cooling the solution to a temperature between 0° C. and 15° C., preferably about 4° C., mixing the solution with poly(ethylene oxide)99-poly(propylene oxide)67-poly(ethylene oxide)99 (“Pluronic F127”) to form a mixture, and storing the mixture at a temperature of from 25° C. to 45° C. preferably about 37° C., to form a gel. The weight ratio of HA to gelatin-Type A is between 1:2 and 2:1 and preferably about 1:1. The weight ratio of HA and gelatin-Type A to Pluronic F127 is between 1:3,000 and 1:150 and preferably about 1:2400.

### BRIEF DESCRIPTION OF THE FIGURES

The preferred embodiments of the hyaluronic acid-gelatin crosslinked thermoreversible pluronic hydrogels of the present invention, as well as other objects, features and advantages of this invention, will be apparent from the accompanying drawings wherein:

FIG. 1 is a graph showing the elastic modulus of amplitude sweeps of HA-PF127 composite gels.

FIG. 2 is a graph showing amplitude sweeps for the breakage stress of HA-PF127.

FIG. 3 is a graph showing frequency sweeps of HA-PF127 composite gels.

FIG. 4 is a graph showing temperature sweeps of HA-PF127 gels.

FIG. 5 is a bar graph showing that increasing concentration of HA-PF127 increases the critical solution temperature (“CST”).

FIG. 6 is a bar graph for temperature sweep data showing a negative correlation between CST and additive concentration.

FIG. 7 depicts physical cross-linking of HA with PF127.

FIG. 8 is a graph showing drive amplitude of the atomic force microscopy (“AFM”) versus the response amplitude of the cells.

FIG. 9 is a bar graph showing the ratio of HA-Gelatin to PF127 versus shear modulus of adult human dermal fibroblasts.

FIG. 10A is phase contrast image of a Gelatin-PF127 hydrogel at a concentration of 1:5 gelatin to PF127.

FIG. 10B is phase contrast image of a Gelatin-PF127 hydrogel at a concentration of 1:10 gelatin to PF127.

FIG. 10C is phase contrast image of a Gelatin-PF127 hydrogel at a concentration of 1:20 gelatin to PF127.

FIG. 10D is phase contrast image of a Gelatin-PF127 hydrogel at a concentration of 1:80 gelatin to PF127.

FIG. 10E depicts a phase contrast image of Gelatin-PF127 hydrogels at a control concentration of gelatin to PF127.

FIG. 11 is a bar graph showing cell counts of adult human dermal fibroblasts on Gelatin-PF127 hydrogels at various concentrations of 1:5, 1:10, 1:20, and 1:80 gelatin to PF127 and a control.

FIG. 12 is a surface plot of the 1:80 gelatin to PF127 hydrogel.

FIG. 13A shows a phase contrast image of HA-Gelatin-PF127 hydrogel at a concentration of 1:5 HA-Gelatin to PF127.

FIG. 13B shows a phase contrast image of HA-Gelatin-PF127 hydrogel at a concentration of 1:10 HA-Gelatin to PF127.

FIG. 13C depicts a phase contrast image of HA-Gelatin-PF127 hydrogel at a concentration of 1:20 HA-Gelatin to PF127.

FIG. 13D depicts a phase contrast image of HA-Gelatin-PF127 hydrogel at a concentration of 1:80 HA-Gelatin to PF127.

FIG. 13E depicts a phase contrast image of HA-Gelatin-PF127 hydrogel at a control concentration.

FIG. 14 is a bar graph showing cell counts of adult human dermal fibroblasts encapsulated within HA-Gelatin-PF127 hydrogels at concentrations of 1:5, 1:10, 1:20, and 1:80 and a control concentration.

### DETAILED DESCRIPTION OF THE INVENTION

The present invention uses a micelle gel and crosslinks its spherical micelles with hyaluronic acid and gelatin polymer chains to form a biocompatible, biodegradable thermoreversible hydrogel. The HA-gelatin crosslinked pluronic hydrogels can be used widely for drug delivery, tissue engineering applications, cosmetic and topical dermatologic applications and other potential biomedical applications.

Previously, pluronic copolymer hydrogels have been used for various applications but for cell attachment, fibronectin was used which is very expensive. The present invention produces a hydrogel which is biocompatible, cell-friendly and has variable stiffness, even higher than the plain pluronic hydrogel. The hydrogel can be made easily and can be used for cell growth without the use of fibronectin. Since the hydrogel is a thermoreversible gel, it can be used as a cell delivery vehicle. The hydrogels are not formed using any harsh chemical crosslinkers so that they are even more valuable for biomedical applications. The HA-gelatin-pluronic hydrogel construct has multiple advantages over currently available chemically crosslinked pluronic constructs in biocompatibility, cost, and tunable physical properties.

The triblock copolymer poly(ethylene oxide)99-poly(propylene oxide)67-poly(ethylene oxide)99 (also referred to herein as “PE099-PP067-PE099” or “Pluronic F127”) has immense potential as the primary component of such hydrogels due to its thermoreversible behavior. While most polymer gels are formed through covalent cross-linking, Pluronic F127 (also referred to herein as “PF127”) is unique for its hydrophobic interactions between triblock copolymer chains. At low temperatures, both PPO and PEO chains are soluble in water. Above the critical solution temperature (CST) at which gelation occurs, the polymers dissolve due to the breaking of hydrogen bonds between water molecules and the chains, and PPO becomes hydrophobic. Hydrophobic reactions lead to the formation of micelles with a PPO core and PEO corona, forming a face-centered cubic nanostructured hydrogel. At even higher temperatures, the micelles aggregate together into hexagonally packed cylinders.

By adjusting the temperature, PF127 can be manipulated to have vastly different mechanical properties, including stiffness that is similar to that of natural tissue. This thermoreversibility is also useful for cell delivery because cells can be encapsulated in the sol state and easily inserted into the body in a minimally invasive manner. Once the solution enters the body, gelation is induced via temperature change and the hardened gel protects the cells from the shear forces within the body. The thermal change is also relatively gentle to the cells, which is in direct contrast to the formation of common scaffolding materials, such as poly(lactide-co-1 glycolide) or PLG, which is processed under relatively severe conditions that are detrimental to cell viability. However, based on previous research, PF127 hydrogels demonstrate poor mechanical properties, such as low yield strengths, as the micelle layers can easily slide past each other under shearing conditions. Moreover, cell viability tests on concentrations of PF127 from 15-20% (w/w) demonstrated complete cell death by 5 days.

Hyaluronic acid (HA) (also called hyaluronic acid or hyaluronate) is a biocompatible polysaccharide that is naturally found in every tissue of the body. HA is particularly concentrated in the skin (almost 50% of the HA in the body is found in the skin), cartilage and synovial fluids and is used for a variety of cosmetic and biomedical applications. Moreover, because it is a natural component of extracellular matrices and is heavily prevalent during wound healing, it contributes to cell migration and proliferation. By itself, HA shows potential as scaffolding material but is limited by its fast degradation process.

Hyaluronic acid is an anionic, nonsulfated glycosaminoglycan consisting of repeating disaccharides of alternating D-glucosamine acid and N-acetylglucosamine molecules. HA is a straight-chained polymer with a molecular weight that varies between 800 dalton tetrasaccharides and 13,000,000 dalton polymers. Hyaluronic acid is naturally present in the pericellular gels, in the fundamental substance of connective tissue and in vertebrate organisms, of which it is one of the chief components, in the synovial fluid of joints, in the vitreous humor, in the human umbilical cord tissues and in rooster combs. One of the chief components of the extracellular matrix, hyaluronan contributes significantly to cell proliferation and migration, and may also be involved in the progression of some malignant tumors.

Hyaluronic acid plays a vital role in many biological processes. For example, hyaluronic acid is applied in the tissue repair process, especially in the early stages of granulation, stabilizing the coagulation matrix and controlling its degradation. When skin is exposed to excessive UVB rays, it becomes inflamed (sunburn) and the cells in the dermis stop producing as much hyaluronan, and increase the rate of cell degradation. Hyaluronan degradation products also accumulate in the skin after UV exposure. The application of hyaluronic acid solutions has been found to accelerate healing in patients suffering from sores, wounds and burns. It is also known that hyaluronic acid fractions can be used to facilitate tissue repair, as substitutes for the intraocular fluid, or they can be administered by the intra-articular route to treat joint pathologies.

The physiological activity of HA polymers and oligomers makes it a promising material for a variety of applications. HA gels are popular for cell culture scaffolds in tissue engineering. However, HA must be crosslinked to achieve the proper mechanical properties and not be digested by HA aces enzymes (i.e., angiotensin-converting enzyme). Most commercially available HA hydrogels are chemically crosslinked where the chemicals are cytotoxic. In addition, these chemicals are expensive and increase the prices of the gels so they are not commercially viable.

It has been shown that chemical cross-linking between HA and collagen creates a hydrogel with mechanical properties superior to HA. However, such chemical changes are generally irreversible and are not as easy to conduct as the physical cross-linking done with PF127. It has been found that the addition of HA to PF127 creates a polymer blend that reduces HA degradation, improves cell viability, and enhances the mechanical properties of the gel, specifically its elastic modulus, while maintaining thermoreversibility.

Another component of the polymer blend is gelatin, a semi-solid colloid derived from collagen. Gelatin is a biodegradable, biocompatible denatured collagen which increases cell adhesion, migration, proliferation and differentiation. Gelatin is derived from collagen, an insoluble fibrous protein that occurs in vertebrates and is the principal constituent of connective tissues and bones. Collagen is distinctive in that it contains an unusual high level of the cyclic amino acids proline and hydroxyproline. Collagen consists of three helical polypeptide chains wound around each other and connected by intermolecular cross-links. Gelatin is recovered from collagen by hydrolysis. There are several varieties of gelatin, the composition of which depends on the source of collagen and the hydrolytic treatment used. Gelatin-type A is derived from an acid-treated precursor, such as porcine skin.

Gelatin is a promising scaffolding material due to its high cell adhesion and biocompatibility. It is a low cost material that improves cell viability. Gelatin was used to enhance the elastic modulus of PF127 hydrogels and increase cell adhesion during encapsulation and scaffolding. However, gelatin can be quickly degraded in the body by gelatinases, so gelatin is physically cross-linked with PF127 to prevent the rapid digestion of gelatin.

Gelatin in solution is amphoteric, capable of acting either as an acid or as a base. In acidic solutions, gelatin is positively charged and migrates as a cation in an electric field. In alkaline solutions, gelatin is negatively charged and migrates as an anion. The pH of the intermediate point, where the net charge is zero and no movement occurs, is known as the Isoelectric Point (IEP) (28). Type A gelatin has a broad isoelectric range between pH 7 and 9. Type B has a narrower isoelectric range between pH 4.7 and 5.4 (29-32).

A preferred thermoreversible surfactant gel is Poloxamer 407, which is a hydrophilic non-ionic surfactant of the more general class of copolymers known as poloxamers. Poloxamer 407 is a triblock copolymer consisting of a central hydrophobic block of polypropylene glycol (PPG) flanked by two hydrophilic blocks of polyethylene glycol (PEG) with the general formula HO(C₂H₄O)a(-C₃H₆O)b(C₂H₄O)aH. The structure of PF (poloxamer 407) is

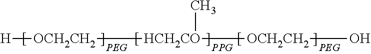

The approximate length of the two PEG blocks is 101 repeat units, while the approximate length of the propylene glycol block is 56 repeat units. This particular compound is also known by the BASF trade name PLURONIC® F127 (also referred to herein as “Pluronic F127”).

The hydrogels are formed by combining a thermoreversible gel, preferably Pluronic F127, with HA and a gelatin, preferably gelatin-Type A. Gelatin is added for cell attachment because HA and Pluronic F127 alone do not promote cell attachment. Preferably, the HA and gelatin-Type A are combined in approximately equal amounts and the amount of Pluronic F127 can be added in a ratio of 1:100 to 1:1.5, preferably 1:24 to 1:1.5 (on a weight percent basis) in order to vary the stiffness of the hydrogels. The hydrogels can include other components that are useful for specific applications or they can consist of or consist essentially of a thermoreversible gel, HA and a gelatin. When the hydrogels comprise a thermoreversible gel, HA and a gelatin, they may include other components. When the hydrogels consist of a thermoreversible gel, HA and a gelatin, they do not include other components except for impurities that one of ordinary skill would normally expect to find in such hydrogels. When the hydrogels consist essentially of a thermoreversible gel, HA and a gelatin, they may include other components that do not materially affect the basic and novel characteristics. HA-gelatin crosslinked Pluronic hydrogels have various advantages in biomedical and cosmetic applications. Cross slinking of the components can be carried out using any of several well-known crosslinking methods, preferably irradiation.

Suitable surfactants include both ionic and non-ionic materials from both synthetic and natural origins, including but not limited to lecithin, glyceryl esters, sugar esters, polysorbates, mono and diglycerides of fatty acids, propylene glycol esters, sucrose fatty acid esters, polyoxyethylene derivatives of sorbitan fatty acid esters, and simethicone. Examples of useful polysorbates include sorbitan trioleate, sorbitan monopalmitate, sorbitan monolaurate, propylene glycol monolaurate, glycerol monostearate, diglycerol monostearate, and glycerol lactyl-palmitate. Lactic acid derivatives include, but are not limited to, sodium stearoyl lactylate and calcium stearoyl lactylate. In one embodiment, when a surfactant is present in the second coating layer, the level of surfactant is present in an amount, based upon the total weight of the second coating layer, of from about 0.5 percent to about 10 percent. In one embodiment, magnesium stearate is used at a level of about 2 percent to about 20 percent by weight of the second coating.

Rheological analysis was performed on the hydrogels with emphasis on changes in elastic modulus and CST. The tests indicated that the introduction of HA and gelatin induced physical cross-linking with PPO and PEO strands, thereby increasing stiffness and stability. To test the predicted synergistic effects of biocompatibility, biodegradability, cellular adhesion, and thermoreversibility, adult human dermal fibroblasts (AHDF) were plated to record growth on three-dimensional scaffolds of the hydrogel. Cells were also encapsulated within the gels to assess the viability of a three-dimensional cell delivery system.

Since the applications of these hydrogels are diverse and physiological conditions vary greatly from person to person, the effects of additives were studied. Of particular interest were glucose and sodium chloride, both of which can be found in varying concentrations due to common diseases, such as diabetes and hypernatremia. A previous study showed that a minimal decrease in storage modulus occurs with the introduction of physiologically relevant additives to PF127. This indicated that both glucose and sodium chloride have a minimal effect on the mechanical properties of the composite hydrogels.

The composite hydrogels have multifaceted applications in a variety of disciplines. The gel itself, with the addition of HA, becomes suitable for injection within the spinal cord, where HA is present in the synovial fluid. Because the hydrogel can mimic the mechanical properties of naturally soft tissue, it can be implemented to fill the empty cavities created by degenerative disc disease. These gels can also be used to create scaffolds for burn victims and those who need replacement tissues and organs. Additionally, the manipulation of the hydrogel can lead to suitable delivery systems for cells, drugs, and genes. By changing the mechanical properties of this gel, it is possible to create a strong carrier system that degrades slowly for the controlled release of other molecules.

### EXAMPLES

The examples set forth below serve to provide further appreciation of the invention but are not meant in any way to restrict the scope of the invention.

### Creation of Composite Hydrogels

PF127 (powder, CAS: 9003 P2443 BioReagent, Sigma Aldrich, USA) was physically cross-linked with varying concentrations of hyaluronic acid (Lifecore) and gelatin (type A from porcine skin, ˜300 Bloom, Sigma Aldrich, USA). A 30% (w/v) stock solution of PF127 was made by dissolving 4.5 g of PF127 polymer in 15 mL of Dulbecco's Modified Eagle's Medium (“DMEM”) in 20 mL scintillation vials. The solution was stirred and cooled at 4° C. to allow the PF127 to dissolve. 30% (w/v) stock solutions of PF127 were also made in deionized (DI) water using the same process. The solutions were stirred several times and kept at 4° C. overnight to allow for all of the PF127 to dissolve. High molecular weight hyaluronic acid (HA) (0.02 g) was dissolved in 4 mL DMEM to create a solution of 0.5% (w/v) HA. A 0.5% (w/v) stock solution of gelatin was made by dissolving 0.02 g of gelatin powder in 4 mL of phosphate buffer saline (Gibco) using a 50 mL plastic test tube. A mixed stock solution of 0.5% (w/v) HA and 0.5% (w/v) gelatin (i.e., a 1:1 ratio of HA:gelatin on a weight basis) was created by dissolving 0.04 g of HA in 4 mL DMEM, and 0.04 g of gelatin in 4 mL of DMEM, and then mixing the two solutions in equal volume ratio.

For rheological purposes, the gels did not have to be sterile. One-fourth ounce metal tin pans were placed on an ice block as PF127 solutions were pipetted to create the 2 mL gels. Then 0.5% HA and 0.5% gelatin solutions were separately added in the volume ratios of 1:4, 1:5, 1:6, 1:10, 1:20, 1:80, and 1:100 of HA or gelatin solutions to 30% PF127 or a HA+gelatin solution was added in the volume ratios of 1:80 and 1:20 HA+gelatin:PF127. In all but HA+gelatin, gels were made in both DMEM and deionized water (also referred to herein as “DI” or “DI water”). As controls, pure PF127 and pure HA gels were made. The solutions were mixed with pipette tips and kept at room temperature to induce gelation.

### Creation of PF127-Glucose and PF127-Sodium Chloride (NaCl) Hydrogels

Rheological testing was conducted on gels with the additives glucose (+/−D Glucose, Sigma Aldrich, USA) and sodium chloride (Sigma Aldrich, USA). Thirty percent (w/v) PF127 solutions were made in DMEM. Solutions were mixed with 0.001%, 0.002%, 0.003%, 0.005%, 0.625% (hypoglycemic), 1.250%, 5.000% (normal), and 10.00% (hyperglycemic) glucose; for salt, concentrations of 0.225%, 0.45%, 0.90% (normal), 1.80%, and 3.60% NaCl were used to mimic the range of low to high glucose and salt concentration within the body. Required volumes of 30% PF127 and the additive were pipetted and mixed with 0.5% HA to make 1:80 (v/v) HA-PF127 gels with the appropriate concentrations of additives using the protocol disclosed above.

### Rheological Analysis of Hydrogels

In order to test the viscoelastic properties of the various composite hydrogels that were made, more than 200 amplitude, frequency, and temperature sweeps were conducted on the gels. The rheometer (Bohlin Gemini HR, ETO Electronics) was calibrated by placing an empty ¼ ounce metal tin pan on the platform and zeroing the rheometer.

### Amplitude Sweeps of Hydrogels

An oscillating geometer (parallel plate, 20 mm diameter) was used to run amplitude sweeps on each of the gels. Through amplitude sweeps, the effect of shear stress (Pa) on the G′ elastic modulus (Pa) was recorded. Frequency was kept constant at 1 Hz, temperature was kept constant at 37° C. to mimic conditions within the body, and the composite hydrogels were subjected to shear stresses ranging from 1 Pa to 5000 Pa. The stress value at which the elastic modulus of the gel began to drop drastically was recorded as the breaking stress and the safe stress was calculated as 10% of the breaking stress. The safe stress was needed for subsequent frequency and temperature sweeps.

### Frequency Sweeps of Hydrogels

The safe stress obtained from the amplitude sweeps was used to run a frequency sweep on each of the gels. Stress was kept constant while oscillation frequency of the geometer was varied from 0.1 Hz to 100 Hz. Temperature was kept constant at 37° C. The frequency sweep provides information regarding the stability of the hydrogel and demonstrates the relationship between oscillation of the geometer and elastic modulus.

### Temperature Sweeps of Hydrogels

Since PF127 is a thermoreversible hydrogel, the temperature of the rheometer platform was varied and all of the composite hydrogels were tested to see if the combinations of HA, gelatin, glucose, sodium chloride, and PF127 caused any differences in gelation temperature, which would be significant in the medical setting. The platform was cooled to 5° C., at which the gel was placed on the platform. A metal covering was placed around the metal tin pans to prevent environmental heat from affecting the gels. The temperature at which the elastic modulus made a drastic jump towards a higher value was recorded as the CST of the gel. If the jump was more gradual, the average of the points forming the gradual jump was taken to obtain the CST.

### Micelle Calculations

To further quantify the test data, the number of chains of polymer additive per micelle of PF127 was calculated to discover the optimal nanostructure for the gels. This was done for all concentrations of HA-PF127 and gelatin-PF127 using the molecular weights of PF127 and HA. It was found that there are 60 PF127 chains per micelle, which means that, in a 1:4800 (wt ratio) gel, there is about 1 chain of HA per 10,000 micelles of PF127.

### Example 1

A hydrogel was formed by combining 30% (w/v) stock solution of Pluronic F127 (“PF127”), 0.5% (w/v) HA and 0.5% (w/v) gelatin-Type A. HA and gelatin were mixed in 1:1 (v/v) ratio (equal to a 1:1 weight ratio of HA:gelatin) and then finally added to Pluronic F-127 solution at 4° C. in a ratio of 1:80 (v/v), 1:20 (v/v) and 1:5 (v/v) [HA-gelatin:Pluronic F-127] (equal to 1:2400, 1:600 and 1:150, respectively, on a weight ratio basis). This solution was swirled around gently and then stored at 37° C. for the gel formation. Varying the ratio of HA-gelatin:Pluronic F-127 yielded gels of variable stiffness. As the concentration of HA increases, the gels increase in stiffness and peaks at a ratio of 1:80 (v/v).

### Example 2

Three-dimensional scaffolds were formed for Atomic Force Microscopy and cell counting. CF-29 adult human dermal fibroblasts (AHDF) were plated on the surface of composite hydrogels containing HA and gelatin (1:1) and PF127 in DMEM in ratios of 1:80, 1:20, 1:10 and 1:5 HA-gelatin to PF127 on a v/v basis. HA was used because it is biocompatible and when used in small amounts, it can be very cost effective. Gelatin was used to enhance cell adhesion to the gel. The gels were made and kept in the incubator prior to cell plating. Under a biosafety cabinet (Labconco purified class II), the liquid mixture of HA, gelatin, and PF127 was filtered through a 20 μm filter. Cells were passaged by standard procedure using the enzyme trypsin. 10,000 CF-29 AHDF cells were plated in each well containing the gels. Two gels were made of each concentration for atomic force microscopy. The control contained cells in DMEM with no gel. The gels and control were incubated at 37° C. for 24 hours. Two gels of each concentration were also made for cell counting.

The next day, an Olympus 1×51 phase contrast microscope and an Olympus DP300BW camera were used to take phase contrast images of the cells at 10× magnification. Shear Modulation Force Microscopy was conducted on the gels to test the response of the cells to the elastic modulus of the gels using an atomic force microscope (Vicco Instruments) with a 20 mm tip. For each gel concentration, three tests were conducted on three different cells, with a total of nine tests for each gel. A graph was obtained for each test showing the effect of the driving amplitude of the tip on the response amplitude of the cell. The slope of the best-fit line was calculated and averaged (S_{avg}) to find the relative shear modulus (E) of the cells for each gel concentration using:

E=(1/S_{avg})^{2/3}

After 24 hours, the media was aspirated from each well for cell counting. PBS was added to the wells and aspirated. Cells were trypsinized for 4 minutes to allow them to fully detach from the gel and then DMEM was added. The dilution factor used was 1×. 10 μL of trypsinized cells were placed on each side of a hemocytometer. Cell counts were conducted using an optical microscope after one day because only 24 hours are needed for cells to adhere to the gel, making it a viable scaffold for use in the real world. To assess the effects of using a composite hydrogel of gelatin and PF127 without HA, gels with the concentrations of 1:80, 1:20, 1:10, and 1:5 gelatin to PF127 on a v/v basis were then made and allowed to gel before plating 50,000 CF-29 AHDF cells per well in a 12 well plate along with 2 controls on DMEM without any gel. The gels and controls were incubated at 37° C. overnight. The next day, several phase contrast images (10×) were taken of each gel. The number of cells per pixel area was calculated by finding the average number of cells on each type of gel using the phase contrast images.

### Example 3

A three-dimensional (3D) cell delivery system was formed with CF-29 AHDF and Green Fluorescent Protein (GFP)-labeled AHDF for imaging and cell counting. To create the 3D cell delivery system, enough gels were created to perform cell counts for several days; however, the PF127 began to gel during the process of filling the wells with PF127 because many gels were being made at once. Therefore, a 6 well plate was used to make one gel each of 1:80, 1:20, 1:10, and 1:5 HA-gelatin to PF127 on a v/v basis in addition to a control with only Dulbecco's Modified Eagle's Medium (“DMEM”) and cells. PF127 was added to the wells according to the ratios of HA-gelatin to PF127. The 0.5% (w/v) HA-gelatin solution was mixed with CF-29 AHDF and then added to the PF127 that was in a viscous liquid form in the wells according to the ratios. 15,000 cells were plated per well by mixing the cells, HA, gelatin and PF127 thoroughly by swishing the plate around while on an ice block. The solutions gelled overnight in an incubator at 37° C. The next day, the presence of cells was confirmed using the optical microscope. Phase contrast images (10×) were then taken of the gels. Cell counts were done after one day because when creating a 3D cell delivery system, the cells need to adhere to the gel and display homogenous distribution, which only requires 24 hours. A phase contrast microscope was used to analyze whether the cells were homogenously mixed in the gels. Confocal imaging could not be used without staining the gels, which would dissolve the gels, so GFP-labeled AHDF was encapsulated within the gels and phase contrast images were taken by following the above procedure.

### Example 4

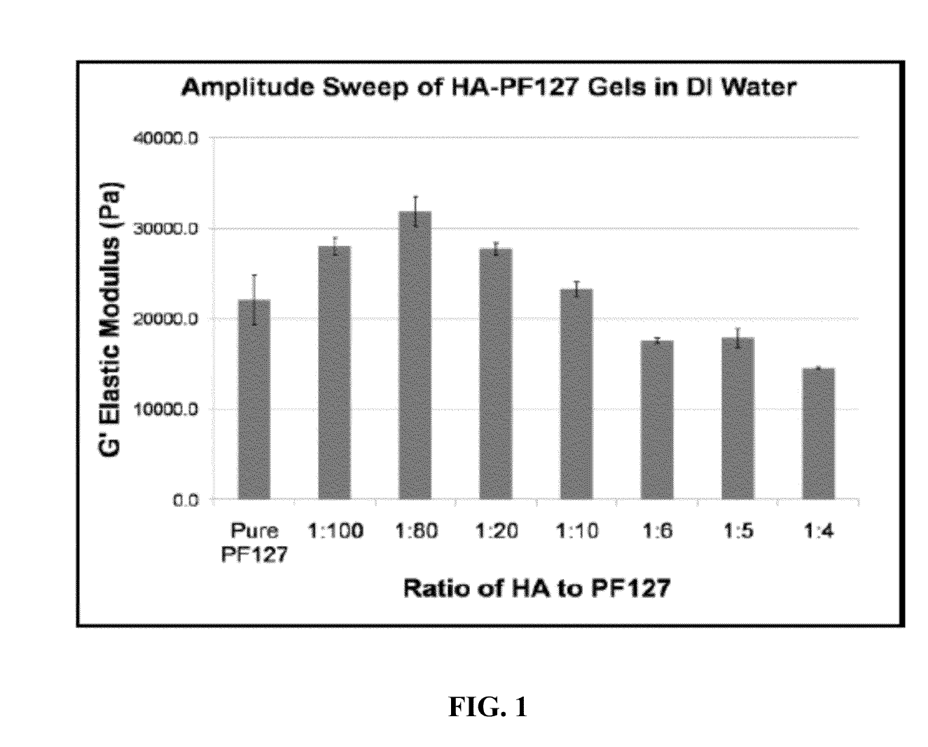

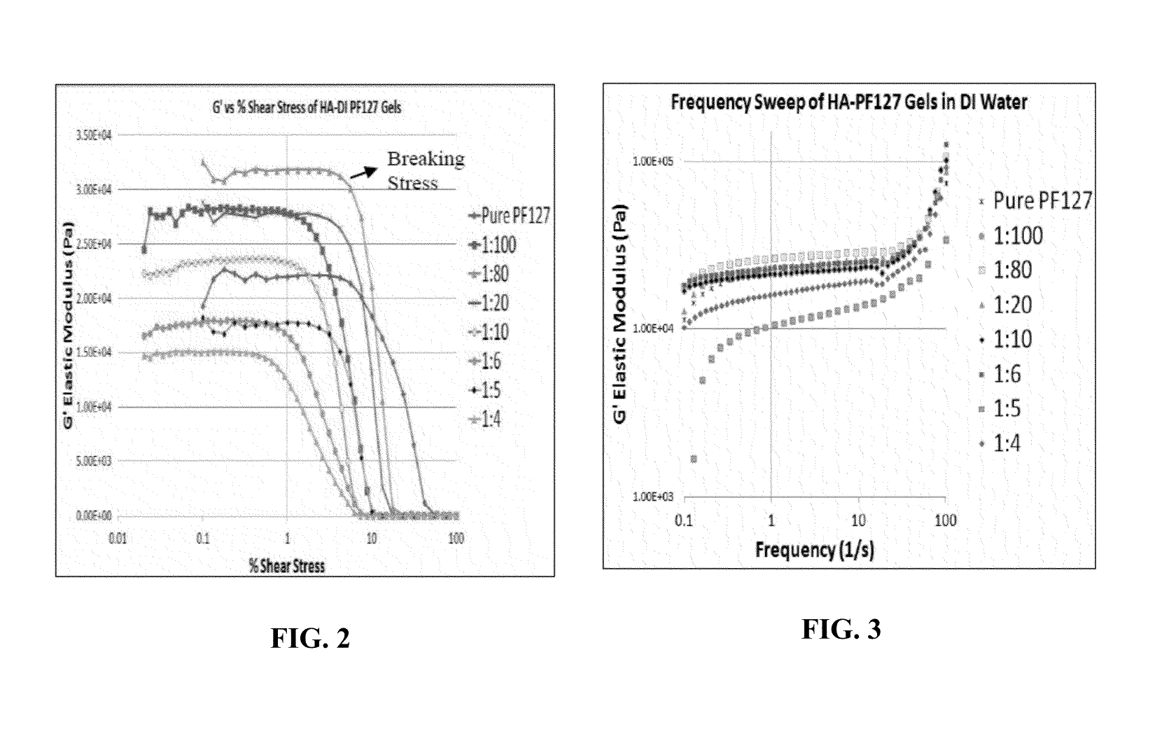

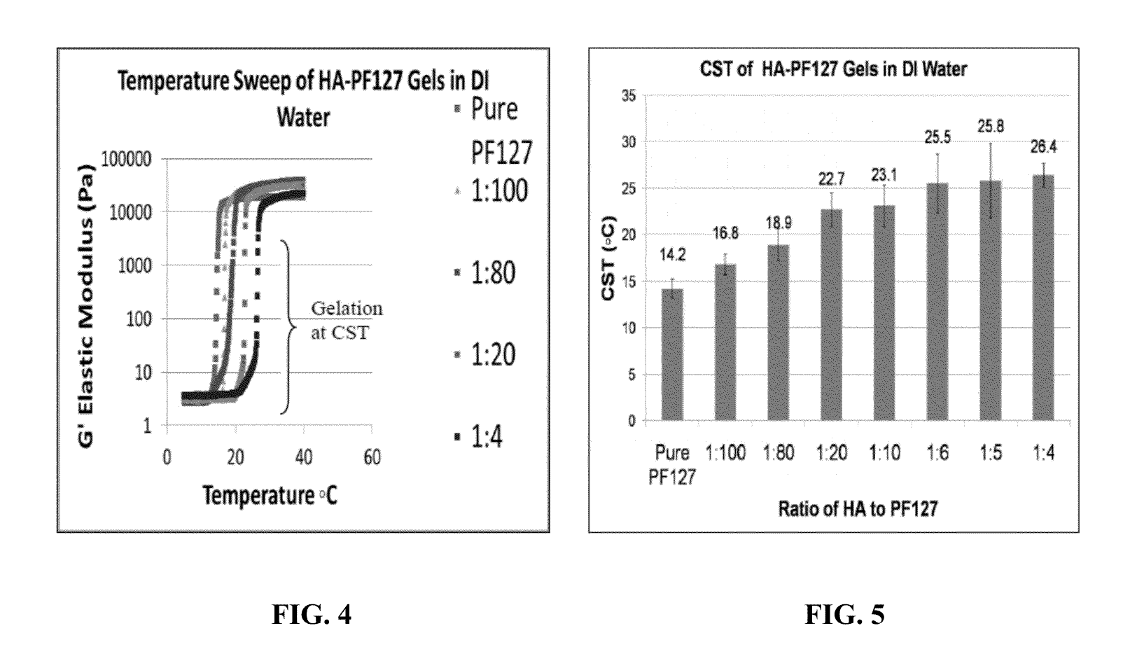

Amplitude sweep results showed that the addition of HA increased the elastic modulus substantially. The maximum gain in elastic modulus occurred at the concentration of 1:80 (v/v) HA:PF127, where an improvement of about 50% was seen compared with pure PF127 (FIG. 1). However, as the concentration of HA increased past 1:80, the elastic modulus decreased, with only a small amount of error. Amplitude testing showed that the 1:80 (v/v) gel had a higher breaking point than any other gel, with breaking stress decreasing as concentration of HA increased (FIG. 2). Frequency sweep testing verified the stability of the HA-PF127, demonstrated the trend in elastic modulus that was previously described in amplitude sweeps, and displayed the gradual shear hardening of the gels (FIG. 3) with a controlled safe stress at a constant temperature of 37° C. Analysis of critical solution temperature (“CST”) through temperature sweeps showed a positive correlation between CST and HA concentration, which was statistically significant according to ANOVA tests (i.e., ANalysis Of VAriance between groups—a statistical method that yields values that can be tested to determine whether a significant relation exists between variables) for DI (p=0.002), where p must be less than or equal to 0.005 to be statistically significant (FIGS. 4 and 5). FIG. 4 shows an increasing CST as the concentration of HA increases and FIG. 5 shows that increasing the concentration of HA-PF127 increases CST, but the trend that begins to plateau after 1:10. For pure HA, the average elastic modulus was 6.75 Pa, which is significantly less than that of any other sample. In DMEM, the differences in elastic modulus were found to be highly statistically significant with p equaling 9.44×10⁻¹⁰ in ANOVA tests.

### Example 5

Amplitude sweeps were conducted on gelatin-PF127 gels in the same set of concentrations as HA-PF127. Of particular note, compared to HA-PF127, gelatin-PF127 gels were stiffer and possessed elastic moduli of about 10,000 kPa greater than their respective HA-PF127 gels of the same concentration. The ANOVA p value for DI was almost zero. It was seen that 1:100 (v/v) had the highest elastic modulus, with 1:80 (v/v) being similar. Temperature sweep data showed that the CST for gelatin-PF127 gels was lower than for HA-PF127 gels, but the general trend of increasing CST as concentration of cross-linking polymer increases was still apparent.

### Example 6

Rheological tests of HA-PF127 and gelatin-PF127 were performed in DMEM solution as well as DI water. Results were similar and showed insignificant variation in elastic modulus and CST. This signifies that the addition of peptides, salts, glucose, and growth factors needed for cell growth would have minimal effects on the mechanical properties of composite hydrogels.

### Example 7

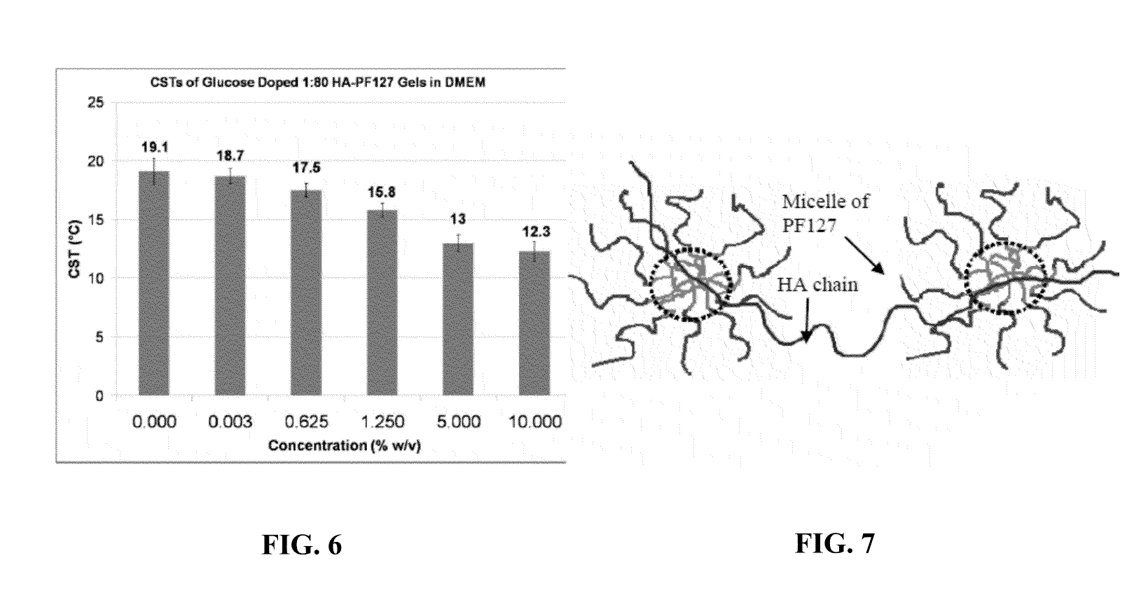

In order to accurately assess the mechanical properties of the gels in the human body, testing on glucose and sodium chloride was performed. Because 1:80 HA-PF127 had high potential in cell scaffolding and delivery, it was used as the control. It was revealed in amplitude sweep tests that varying concentrations of glucose had a minimal effect on the elastic modulus. Temperature sweep data revealed a decrease in CST with increasing additive concentration, a direct opposite of the trend seen for both HA-PF127 and gelatin-PF127 composite gels (FIG. 6). The effects of salt were similar to those of glucose with an even greater decreasing trend in CST.

### Example 8

Amplitude sweeps on 1:80 and 1:20 (v/v) HA-gelatin-PF127 hydrogels showed an increase in elastic modulus from 1:80 to 1:20, which is the opposite of what was seen in HA-PF127 and gelatin-PF127. Both of these elastic moduli were greater than that of pure PF127. However, the difference was not significantly large. Also, increasing the concentration of HA-gelatin decreased the CST.

### Example 9

Table 1 shows the relationship between the concentration of HA and of gelatin and the number of chains of these polymers per 10,000 micelles of PF127. As HA and gelatin concentration increases, the number of chains of HA and of gelatin per 10,000 micelles increases. FIG. 7 is a modified diagram of the physical cross-linking of HA and PF127.

TABLE 1
Number of chains of HA and gelatin per 10,000 micelles of PF127

| Ratio of 0.5% HA to | | |
|---|---|---|
| 30% PF127 | Chains of HA per | Chains of gelatin per |
| (v/v) | 10,000 PF127 micelles | 10,000 PF127 micelles |
| 1:100 | 1.05 | 16.8 |
| 1:80 | 1.06 | 17.0 |
| 1:20 | 5.60 | 89.0 |
| 1:10 | 10.0 | 170 |

### Example 10

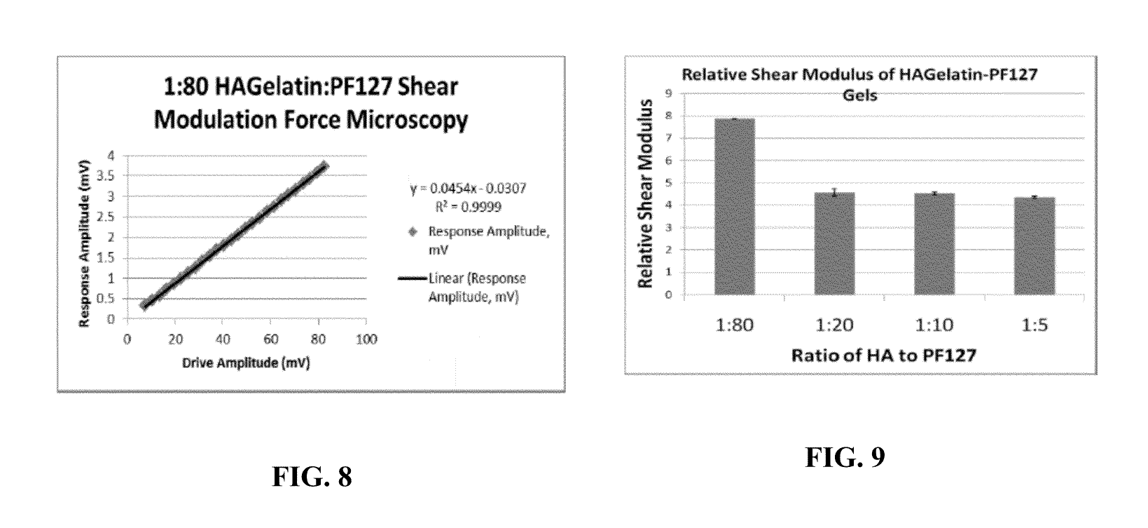

Shear Modulation Force Microscopy tests were conducted on the HA-gelatin-PF127 2D hydrogels using an atomic force microscope. FIG. 8 shows the value of the response amplitude of the cells in response to the driving amplitude for one cell on a 1:80 (v/v) HA-gelatin:PF127 hydrogel. As the drive amplitude of the AFM tip increases, the response amplitude of the cells increases in a linear fashion. FIG. 9 is a consolidated representation of how the elastic modulus is related to the calculated relative shear modulus of the cells. FIG. 9 shows the effect of the ratio of HA-gelatin to PF127 on the relative shear modulus of adult human dermal fibroblasts. Of note is that 1:80's shear modulus far surpassed the rest. For the cell growth assay, the control sample showed an increase in the number of cells in the well when counting using the hemocytometer. It was found that there were more cells on the 1:80 HA-gelatin:PF127 hydrogel than the rest of the HA-gelatin-PF127 gels.

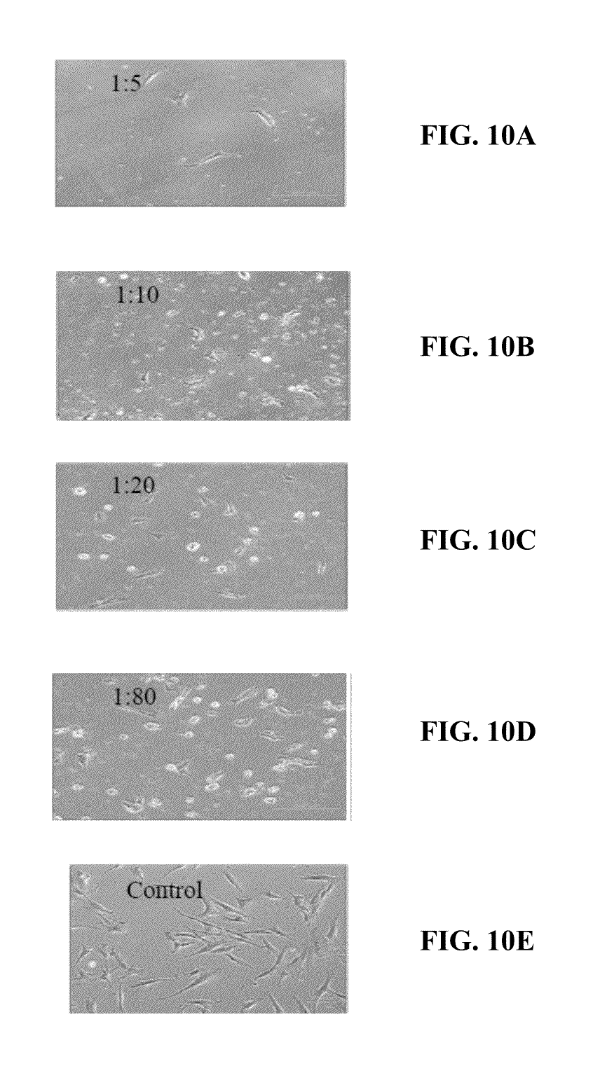

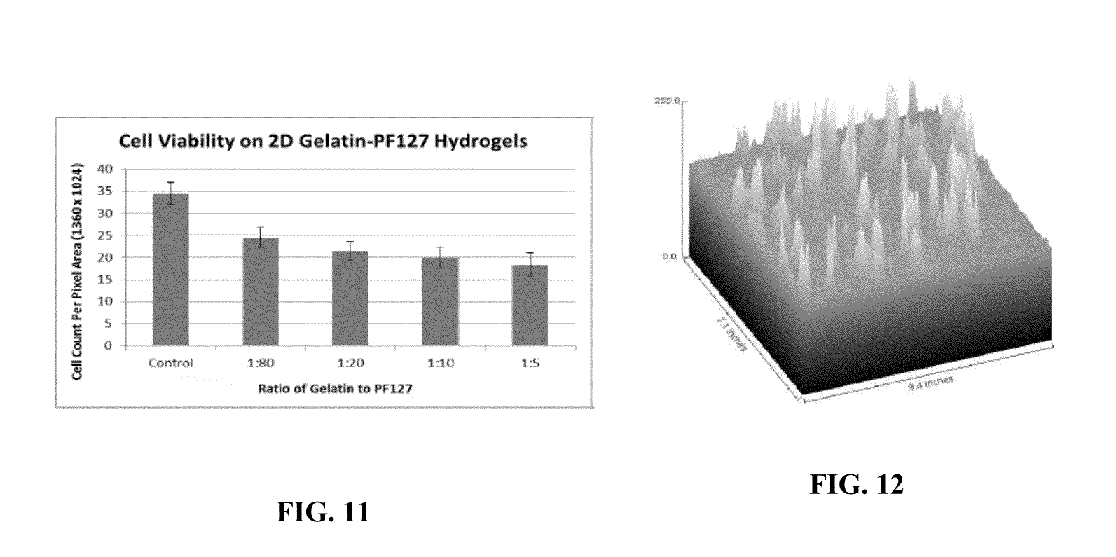

Phase contrast images of the 2D gelatin-PF127 hydrogels were taken one day after cell plating. FIG. 10 shows phase contrast images (10×) of gelatin-PF127 hydrogels at concentrations of 1:5, 1:10, 1:20 and 1:80 on a v/v basis gelatin to PF127. Cell growth indicates that the 1:80 hydrogel was preferable for cell viability and that minimizing the concentration of gelatin increases cell viability. The relationship between ratio of gelatin to PF127 and cell count per pixel area was determined. FIG. 11 shows cell counts of adult human dermal fibroblasts on gelatin-PF127 hydrogels at concentrations of 1:5, 1:10, 1:20 and 1:80 (v/v) gelatin to PF127. Cell counts indicate that the 1:80 hydrogel was preferable for cell viability and that decreasing the concentration of gelatin increases cell survival. Surface plots of the 2D gels were made to view the topography of the gels and to determine if the cells were on top of the gel. FIG. 12 shows a surface plot of the 1:80 (v/v) gelatin to PF127 hydrogel. The peaks represent areas of high topography due to the presence of cells on the surface of the gels.

### Example 11

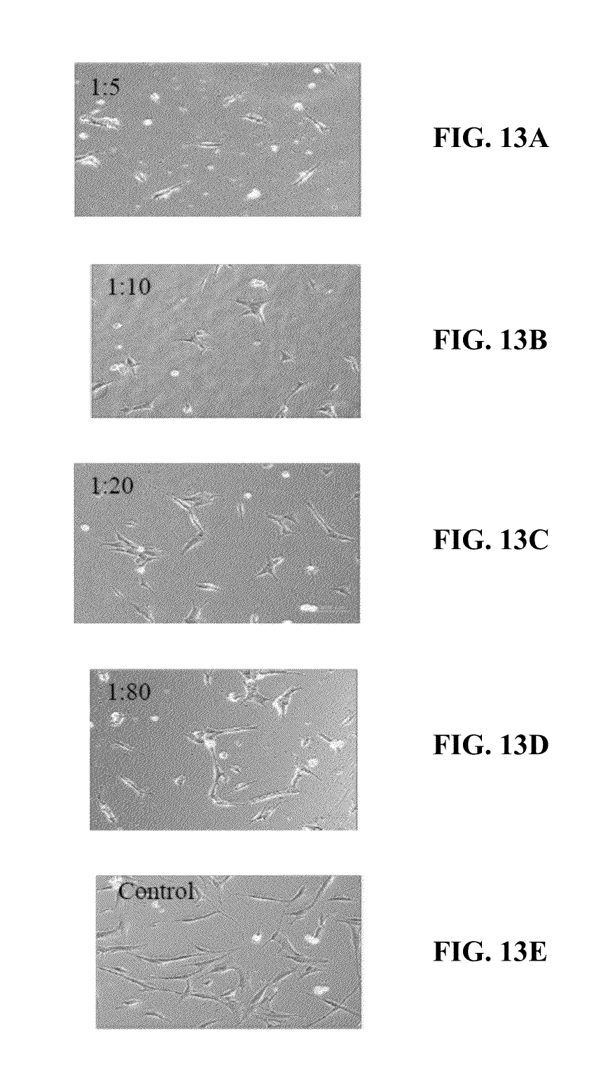

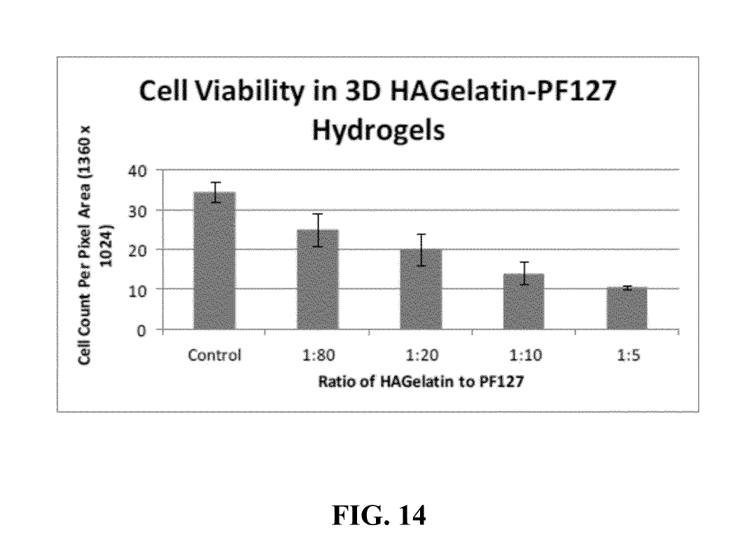

Phase contrast images were taken of the 3D HA-gelatin-PF127 hydrogels one day after cell plating. FIG. 13 shows phase contrast images (10×) of HA-gelatin(1:1)-PF127 hydrogels at concentrations of 1:5, 1:10, 1:20 and 1:80 on a v/v basis HA-gelatin to PF127. Cell growth indicates that the 1:80 hydrogel was preferable for cell viability when encapsulated and that decreasing the concentration of HA and gelatin increases cell viability. The most cells grew in 1:80 (v/v) HA-gelatin-PF127 and the statistically significant ANOVA p value was close to 0 (5.94×10⁴). FIG. 14 shows cell counts of adult human dermal fibroblasts encapsulated within HA-gelatin(1:1)-PF127 hydrogels at concentrations of 1:5, 1:10, 1:20, and 1:80 on a v/v basis HA-gelatin to PF127 were obtained using phase contrast images. Cell counts indicate that the 1:80 hydrogel was preferable for cell viability while encapsulated and that decreasing the concentration of HA-gelatin increases cell survival.

### Example 12

Phase contrast images were taken one day after GFP labeled CF-29 AHDF were encapsulated within HA-gelatin-PF127 hydrogels. The images showed the cells in various layers of the gel. The homogenous nature of the encapsulated cells within the 3D hydrogel matrix was apparent because some cells were a brighter shade of green than others and some appeared to be farther away in the images, which made those cells look smaller than those that were in the top layers of the gel.

### Rheology

Rheological analysis showed that the composite hydrogels had significantly improved mechanical properties when compared with pure PF127 gels. Of note is that for HA-PF127 gels, the elastic modulus increases as concentration of HA increases, up to 1:80. After that point, elastic modulus decreases with increasing concentration until it starts to plateau at 1:6. The significant increase in elastic modulus is due to the entanglements of HA strands with PF127 strands. This physical cross-linking prevents micelle movement and increases stiffness, thereby improving structural stability. The eventual decrease of the elastic modulus may be caused by phase separations at higher concentrations when interactions between individual HA strands become more favorable than HA-PF127 interactions. It was calculated that for optimal stiffness, the number of chains of HA per 10,000 micelles of PF127 is about 1 chain (1:80) (v/v). For gelatin-PF127 composite hydrogels, the effects of the physical cross-links were even more pronounced, with 17 chains of HA per 10,000 micelles of PF127 being optimal for 1:80 (v/v). This explains the increased elastic modulus for the HAPF127 and gelatin-PF127 composite gels.

The additives glucose and salt demonstrated minimal effects on the elastic modulus. However, the two additives heavily influenced the critical solution temperature. In the composite gels with no additives, as concentration of HA or gelatin increased, CST increased. This is due to the fact that more thermal energy is needed to break up the crystalline structure of the hydrogel when individual micelles are entangled by additional polymer chains. However, for additives, the opposite trend was shown. As concentration of glucose or salt increased, the CST decreased due to a “salting out” effect caused by competition over water molecules, as was confirmed by previous research. As a result, the CST required for gelation decreased. The testing on CST is important because for cell delivery, it is vital to encapsulate the cells within the gel before gelation occurs. Overall, the results have shown that both HA-PF127 and gelatin-PF127 composite hydrogels have improved mechanical properties as compared to pure PF127 gels.

### Cell Work

For the purpose of creating a biodegradable scaffold, HA-gelatin-PF127 and gelatin-PF127 hydrogels were created. Shear Modulation Force Microscopy on HA-gelatin-PF127 gels showed the highest relative shear modulus for cells plated on gels with a composition of 1:80 HA-gelatin:PF127, which means that cells respond well to this gel. The 1:80 HA-gelatin-PF127 and 1:80 gelatin-PF127 gels displayed the most cells after one day, indicating that cells prefer these gels due to their high stiffness, and previous research states that high stiffness is needed for cell growth. The gelatin-PF127 hydrogels are suitable for cell scaffolding because gelatin degrades less quickly by enzymes when masked by the PF127 micelles.

In order to create a successful cell delivery system, a certain level of cross-linking is necessary to achieve greater mechanical strength so that the gel does not dissolve or dissipate quickly in vivo. For this reason, HA and gelatin were physically cross-linked with PF127. AHDF displayed the most growth when encapsulated within 1:80 HA-gelatin:PF127 hydrogels. This gel was shown to be the stiffest through rheological analysis, and for this reason, this gel provides the proper mechanical strength needed for cell delivery. The encapsulation of GFP-labeled AHDF showed that the cells were homogenously distributed in the composite gel.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

We claim:

1. A hydrogel comprising:
hyaluronic acid (“HA”);
gelatin-Type A; and
a thermoreversible, hydrophilic non-ionic surfactant gel.

2. The hydrogel according to claim 1, wherein the thermoreversible, hydrophilic non-ionic surfactant gel is a poloxamer.

3. The hydrogel according to claim 1, wherein the gelatin-Type A has an isoelectric range between 7 and 9 pH.

4. The hydrogel according to claim 1, wherein the thermoreversible, hydrophilic non-ionic surfactant gel is poly(ethylene oxide)99-poly(propylene oxide)67-poly(ethylene oxide)99 (“Pluronic F127”).

5. The hydrogel according to claim 1, wherein the weight ratio of HA to gelatin-Type A is between 1:2 and 2:1.

6. The hydrogel according to claim 1, wherein weight ratio of HA to gelatin-Type A is about 1:1.

7. The hydrogel according to claim 1, wherein the weight ratio of HA to gelatin-Type A is between 1:2 and 2:1 and the weight ratio of HA and gelatin-Type A to thermoreversible, hydrophilic non-ionic surfactant gel is between 1:2,400 and 1:150.

8. A hydrogel consisting essentially of:
hyaluronic acid (“HA”);
gelatin-Type A; and
poly(ethylene oxide)99-poly(propylene oxide)67-poly(ethylene oxide)99 (“Pluronic F127”),
wherein the weight ratio of HA and gelatin-Type A to Pluronic F127 is between 1:3,000 and 1:150.

9. The hydrogel according to claim 8, wherein the weight ratio of HA to gelatin-Type A is between 1:2 and 2:1.

10. The hydrogel according to claim 8, wherein the weight ratio of HA to gelatin-Type A is about 1:1.

11. The hydrogel according to claim 8, wherein the weight ratio of HA and gelatin-Type A to Pluronic F127 is between 1:3,000 and 1:150.

12. The hydrogel according to claim 8, wherein the weight ratio of HA and gelatin-Type A to Pluronic F127 is about 1:2,400.

13. A method for forming a hydrogel comprising:
combining hyaluronic acid (“HA”) and gelatin-Type A to form a solution;
cooling the solution to a temperature between 0° C. and 15° C.;
mixing the solution with poly(ethylene oxide)99-poly(propylene oxide)67-poly(ethylene oxide)99 (“Pluronic F127”) to form a mixture; and
storing the mixture at a temperature of from 25° C. to 45° C. to form a gel.

14. The method according to claim 13, wherein the weight ratio of HA to gelatin-Type A is between 1:2 and 2:1.

15. The method according to claim 13, wherein the weight ratio of HA to gelatin-Type A is about 1:1.

16. The method according to claim 13, wherein the weight ratio of HA and gelatin-Type A to Pluronic F127 is between 1:3,000 and 1:150.

17. The method according to claim 13, wherein the weight ratio of HA and gelatin-Type A to Pluronic F127 is about 1:2,400.

18. The method according to claim 13, wherein the solution is cooled at a temperature of about 4° C.

19. The method according to claim 13, wherein the mixture is stored at a temperature of about 37° C.
